(19) United States
(12) Patent Application Publication
(10) Pub. No.: US 2024/0295888 A1
(43) Pub. Date: Sep. 5, 2024

(54) REMOTELY PROGRAMMABLE SENSING AND CONTROL UNIT FOR LIQUID TEMPERATURE AND LEVEL

(71) Applicants: INTEMPCO CONTROLS LTD, Pointe-Claire (CA); M-Tech Control Corporation, Spring, PA (US)

(72) Inventors: John LOJEN, Pointe-Claire (CA); Scott R. MAURER, Wyomissing, PA (US)

(21) Appl. No.: 18/593,351

(22) Filed: Mar. 1, 2024

Related U.S. Application Data
(60) Provisional application No. 63/449,155, filed on Mar. 1, 2023.

(51) Int. Cl. G05D 23/19; G01F 23/263; G05B 19/4155; G05D 9/12; G05D 23/20

(52) U.S. Cl. CPC G05D 23/1917; G01F 23/263; G05B 19/4155; G05D 9/12; G05D 23/2034; G05B 2219/50333

(57) ABSTRACT

A unit which combines a remotely programmable controller with an integral temperature and level sensor for controlling the temperature and level of a given liquid. The device comprises one temperature sensor, to measure a liquid's temperature and to provide an electrical output; one level sensor, to measure a liquid's level and provide an electrical output; a programmable scaling and control module, for receiving the electrical outputs of the temperature sensor and level sensor as input signals, for scaling the temperature signal as a function of temperature and a scale-selection input, and for implementing a control logic to process the sensor signals into two respective control signals; two electronic switching devices, to electrically interface one of the two control signals to an external heater or cooling unit and the other one of the two control signals to an auxiliary device, such as a pump or alarm.

### CROSS-REFERENCE TO RELATED APPLICATION

This application claims priority or benefit from U.S. provisional patent application No. 63/449,155, filed Mar. 1, 2023, the specification of which is hereby incorporated herein by reference in its entirety.

### BACKGROUND

### (a) Field

The subject matter disclosed generally relates to sensors for liquids. More specifically, it relates to a sensor which performs temperature sensing and liquid level sensing within the same housing unit.

### (b) Related Prior Art

In various industries, liquid temperature and liquid level (height of the liquid column) are often critical variables that need to be controlled accurately in various industrial processes. More specifically, there are many processes in which these variables must be measured congruently, and the liquid temperature and liquid level must be controlled congruently, that is simultaneously or altogether.

The current prior-art standard in the industry for implementing a closed-loop control system to adjust liquid temperature and liquid level would be to obtain the necessary sensors separately from the conditioning and control equipment. These components are then interfaced inside of a control panel, along with the necessary power equipment. On top of the time and resources required to design and fabricate the control panel, the user must then go through the tedious process of calibrating each individual sensor with its conditioning module, and then tuning each individual controller separately.

U.S. Pat. No. 7,223,014 proposes a unit which integrates both a sensor and a remotely programmable scaler module within a housing; the scaler module is used to receive the sensor's electrical output and produce a scaled analog signal as a function of said electrical output and a scale selection input. Both the scale selection input and the calibration are adjustable through the data interface; once a remote computer has been connected, a software tool is used to make the alterations. This device is only able to perform the sensing of only one physical quantity, i.e., temperature, and would require an external controller to perform subsequent controls to modify the temperature based on the sensing.

Similarly, U.S. Pat. No. 8,950,255 discloses a design where a “control module” is used to take input from a remote computer and apply that input to process the sensor outputs into industry-standard signal outputs. This disclosure does not incorporate a controller. While the disclosure mentions a “control module” terminology, a careful reading of this prior-art documents reveals that this device is simply intended to provide a sensor output, and it does not determine a control signal intended for use in adjusting the sensed quantities.

U.S. Pat. No. 5,178,009 proposes an integral sensor which measures both temperature and liquid level. The sensor unit does not incorporate internal conditioning nor is it integral with the controller. As a result, the user is left with the burden of selecting and integrating both the conditioning and the control equipment; on top of costing the user both time and resources, this does not reduce the spatial footprint within the control panel, nor does it simplify the calibration and tuning process.

### SUMMARY

The purpose of the present invention is to overcome the outlined problems by combining an integral temperature and level sensor with a programmable scaling and control module inside the same unit (i.e., inside of a single unit). The resultant device does not require external conditioning or control equipment, saving space within the control panel, or eliminating the need for it, thereby providing the technical possibility of removing such external conditioning or control equipment without suffering from it. Pairing the device with a programming software to be run on a remote computer, the programmable scaling and control module simplifies the process of sensor calibration and controller configuration as it provides a common medium through which these settings can be altered.

This disclosure relates to sensors and controllers, specifically those which measure the temperature and level (height) of liquids (such as liquids in a container having a bottom from which a level/height can be measured). More particularly, the Remotely Programmable Sensing and Control Unit for Liquid Temperature and Level, hereinafter called SCU (which stands for Sensing and Control Unit), refers to a unit which comprises:
a temperature sensor, which can be, for example and without limitation, a RTD, thermocouple, thermistor, or solid state (digital IC), along with the necessary conditioning circuitry;
a level sensor, which can operate by basing measurements on either capacitance, conductance, ultrasonic, contact radar, non-contact radar, or vibration, accompanied by the necessary conditioning circuitry; and
a controller which can be programmed or configured to adjust the temperature or level of a liquid medium;
all into a single compact assembly.

Accordingly, an object of the present disclosure is to provide a unit which combines, within the same housing unit, a remotely programmable controller with an integral temperature and level sensor for controlling the temperature or level of a given liquid. The device comprises: one temperature sensor, to measure liquid temperature and provide an output, such as an electrical output, as a function of this quantity; one level sensor, to measure liquid level and provide an output, such as an electrical output as a function of this quantity; a programmable scaling and control module, for receiving the electrical outputs of the temperature and level sensors as signals, scaling the temperature signal as a function of temperature and a scale selection input, and implementing a control logic to process the sensor signals into two (2) control signals; two (2) electronic switching devices, to electrically interface one control signal to an external heater or cooling unit and the other to an auxiliary device, such as a pump or the alarm input of a supervisory system; and a data interface for receiving programming data, the scale selection input, and the control logic from a remote computer, as well as transmitting: settings of the unit as they are stored in the unit, readings of the sensors, and a status of the output.

According to an aspect of the disclosure, there is provided a sensing and control unit for detecting and regulating both temperature and liquid level, comprising:
a temperature sensor and a liquid level sensor which are both integrally housed within the sensing and control unit;
a scaling and control module; and
an output module for sending a signal for temperature control a signal for level control,
   wherein said temperature sensor, liquid level sensor, scaling and control module, and output module are housed within a common enclosed unit which is the sensing and control unit.

According to an embodiment, said scaling and control module is remotely programmable.

According to an embodiment, said scaling and control module is used to transmit the conditioned temperature and level signals.

According to an embodiment, said temperature sensor, liquid level sensor, scaling and control module, and output module are integrated onto a single board which is within the common enclosed unit which is the sensing and control unit.

According to an embodiment, the common enclosed unit which is the sensing and control unit is formed of a main housing and a probe extending from the main housing.

According to an embodiment, the main housing and the probe have an inner volume thereof in common, thereby together forming the common enclosed unit.

According to an embodiment, the single board comprising the temperature sensor, the liquid level sensor, the scaling and control module, and the output module, extends within the inner volume of the main housing and within the probe of the sensing and control unit.

According to an embodiment, the main housing is elongated and extends from a proximal end to a distal end.

According to an embodiment, the main housing is hexagonal at the proximal end and has a NPT connection at the distal end.

According to an embodiment, the probe comprises a tube concentric with a bore of the main housing for connecting thereinto at the distal end of the main housing.

According to an embodiment, the temperature sensor is located in the probe.

According to an embodiment, the temperature sensor is a silicon temperature sensor.

According to an embodiment, a printed circuit board extends within the main housing and protrudes into the probe by a distal end of the probe, forming a protrusion, the temperature sensor is mounted on the protrusion of the printed circuit board, thereby mounting the temperature sensor at the distal end of the probe.

According to an embodiment, the protrusion of the printed circuit board includes a plurality of snap locations at regular locations for snapping off a distal portion of the protrusion to adapt to different probe lengths.

According to an embodiment, the protrusion of the printed circuit board comprises solder pads immediately proximal of each of the plurality of snap locations for soldering the temperature sensor at the distal end of the probe upon snapping off the distal portion of the protrusion.

According to an embodiment, the liquid level sensor is located in the probe.

According to an embodiment, the liquid level sensor comprises two tubes made of an electrically-conductive material as a pair of isolated electrodes, a continuity between the two tubes changing upon submersion in a liquid indicating a level of the liquid.

According to an embodiment, the scaling and control module, and the output module are housed within the main housing.

According to an embodiment, the scaling and control module, and the output module receive signals from the temperature sensor and the liquid level sensor and can output a control on the temperature and on the liquid level.

### BRIEF DESCRIPTION OF THE DRAWINGS

Further features and advantages of the present disclosure will become apparent from the following detailed description, taken in combination with the appended drawings, in which:

FIG. 1 is a block diagram illustrating a circuit for the SCU, according to an embodiment of the disclosure;

FIGS. 2A-2B are a side view and a cross section illustrating the SCU within a single housing unit, according to an embodiment of the disclosure.

FIG. 3 is a flowchart of a control algorithm implemented into the SCU, according to an embodiment of the disclosure.

It will be noted that throughout the appended drawings, like features are identified by like reference numerals.

### DETAILED DESCRIPTION

There is described herein a unit which combines a remotely programmable controller with an integral temperature and level sensor for controlling the temperature or level of a given liquid. The device comprises one temperature sensor, to measure a liquid's temperature and to provide an electrical output as a function of this quantity; one level sensor, to measure a liquid's level and provide an electrical output as a function of this quantity; a programmable scaling and control module, for receiving the electrical outputs of the temperature sensor and level sensor as input signals, scaling the temperature signal as a function of temperature and a scale-selection input, and implementing a control logic to process the sensor signals into two respective control signals; two electronic switching devices, to electrically interface one of the two control signals (corresponding to temperature control) to an external heater or cooling unit, and the other one of the two control signals (corresponding to level control) to an auxiliary device, such as a pump or the alarm input of a supervisory system; and a data interface for receiving programming data, the scale selection input, and the control logic from a remote computer.

The temperature sensor, liquid level sensor, scaling and control module, and output module are all housed together within the same unit (namely the sensing and control unit), which is a common enclosed unit housing all elements therein. The temperature sensor, liquid level sensor, scaling and control module, and output module can all be integrated onto a single board which is within this same common enclosed unit (namely the sensing and control unit).

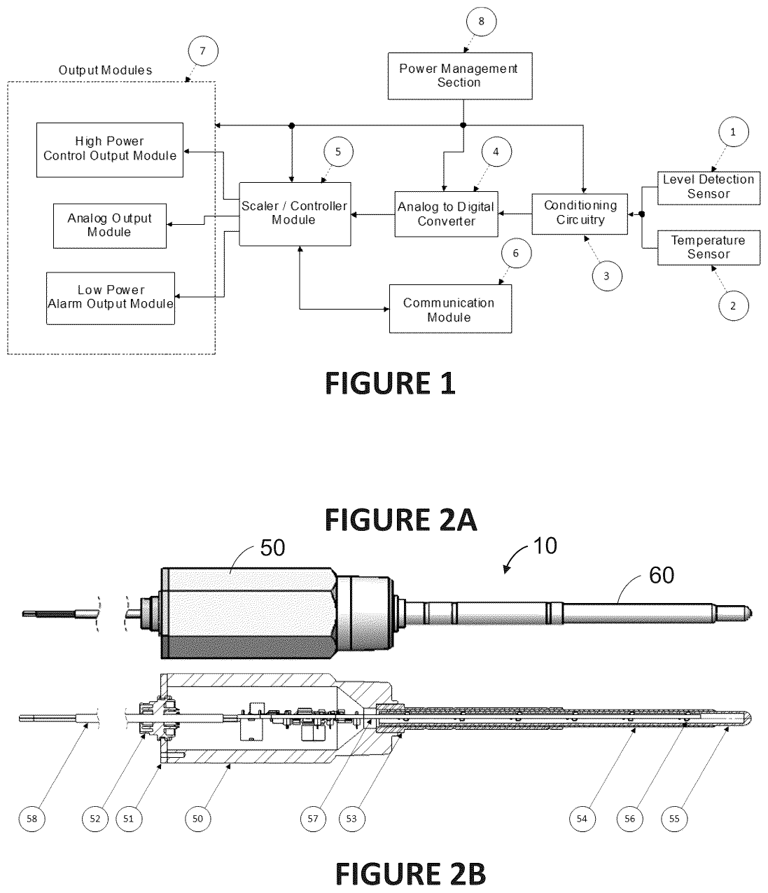

FIG. 1 represents a block diagram of the Sensing and Control Unit or SCU (10). As shown in the diagram, and according to an embodiment of the disclosure, the level-detection sensor 1 and the temperature sensor 2 are each operatively connected to the conditioning circuitry 3, which is used to collect and apply a conditioning treatment on the electrical signals of the sensors such that they meet the input requirements of the analog-to-digital converter 4 (ADC). Once the signals have been conditioned, they are then digitized by the ADC 4, such that the output of the ADC 4 can be transmitted as an input to the scaler/controller module 5. This scaler/controller module 5 is the main component of the unit, as it communicates (with a transceiver for bi-directional communication) with a remote device via the communication module 6 such the user can easily calibrate, re-scale, and configure the SCU to produce the desired output(s) 7 from the sensor measurements. According to an embodiment of the disclosure, each of the components is energized by the power management section 8, which controls the main power supply to satisfy the voltage and current requirements of the various modules of the SCU.

According to a preferred embodiment of the disclosure, and as shown in FIG. 2A, all the components are encased within a single common unit forming the SCU 10. According to an embodiment of the disclosure, this single common unit is formed of two sections: the main housing 50, and the probe 60. As shown in FIGS. 2A-2B, the main housing 50 is elongated (extending between one end and another opposite end) and can be fabricated out of a 4″-long piece of stainless steel and which, according to an exemplary embodiment, is hexagonal on one end (proximal end) and has a 1″ NPT (National Pipe Tapered Thread) connection on the other opposite end (distal end). The hexagonal end has a bore which has a diameter that reduces before going through the other side. To cover the bore, there is a stainless-steel plate 51 with an M16 connector 52. As for the probe, this starts with a 0.5″ O.D. (outside diameter) stainless-steel tube 53 that is welded to be concentric with the bore. Inside the tube, there are two other concentric tubes; the one with a larger diameter 54 is made of polytetrafluoroethylene, where the one with a smaller diameter 55 is made of stainless steel. Forming the entirety of the probe 60, the tubes are crimped together and the unit is enclosed by welding the end of the smallest tube shut. The design can be intended to be used for a variety of different probe lengths, and so the tubes have no designated length (during fabrication, the length can be chosen to fit a specific use, for example).

The probe is where the temperature sensor 2 and the level-detection sensor 1 are located. According to a more specific embodiment of the disclosure, and without limitation, there is a silicon temperature sensor 56 positioned on the inside, near the welded end to measure temperature. As for the liquid level, according to a more specific embodiment of the disclosure, and without limitation, this is measured by using the two tubes made of an electrically-conductive material (which can be stainless steel) as a pair of isolated electrodes. The continuity between these electrodes will change as they become submerged in the same liquid, and this correlation is used as a method of measurement.

While one of the preferred embodiments makes use of a silicon temperature sensor 56 in the temperature sensor 2, there are many other possibilities as to how temperature may be measured; examples would include, without limitation: a resistance temperature detector (RTD), a thermistor, or a thermocouple. Also having regard to the method of level-detection, alternatives can include, without limitation: the measurement of capacitance between two electrodes, or using differentiation in sound propagation (ultrasonic), high-frequency propagation (radar), vibration, and water column pressure between a pair of sensors.

According to an exemplary embodiment of the disclosure, inside of the unit is a single printed circuit board 57 which occupies a significant fraction of the interior volume of the main housing 50 and protrudes out of the main housing 50 to extend approximately to the end of the probe (but still within the inner volume of the common enclosure or common enclosed unit formed of both the main housing and probe), for example to support mechanically the temperature sensor 56 (located at or close to the distal end of the probe as shown in FIG. 2B) and also to provide an electrical connection thereto. More specifically, the protrusion is designed to be snapped at regular intervals to account for the variety of different probe lengths that the SCU is to be offered with. Next to each snap location, there is a set of solder pads for the temperature sensor (e.g., one of these solder pads is shown at the same location as the reference numeral 56 identifying the temperature sensor in FIG. 2B). This allows the temperature sensor 56 to be mounted at the distal end of the probe, despite the different possible probe lengths. In other words, the protrusion of the printed circuit board includes a plurality of snap locations at regular locations for snapping off a distal portion of the protrusion to adapt to different probe lengths, and the protrusion of the printed circuit board comprises solder pads immediately proximal of each of the plurality of snap locations for soldering the temperature sensor at the effective distal end of the probe after having snapped off the distal portion of the protrusion. As for the electrodes, they are simply connected using wire.

According to an exemplary embodiment of the disclosure, the remainder of the electronic components are located on the section of the board which is housed within the main housing 50 of the SCU (and therefore not within the probe). Although there are many variations of the design contemplated within the scope of the disclosure, there is a standard set of components on which each of the other optional components are based. For example, amid the lower-level circuitry, the standard set of components would include: an amplifier stage, used in the conditioning circuitry; an ADC; a microprocessor, used as the scaler/controller module; a signal level shifter, used in the communication module; a mechanical relay, used as the high-power control output module; and voltage regulators, used to power the device. Other optional components would include, but are not limited to: an additional mechanical relay, to be used as the low-power alarm output module; up to two digital-to-analog converters, to be used as the analog output module; and a 3-wire RTD, to provide an RTD output from the SCU. Although these specific components have been selected for the preferred embodiment, they may be altered based on the application of the device; for example, the mechanical relays may be replaced with any other high-power electronic switching device, such as a solid-state relay or a power MOSFET.

According to a preferred embodiment of the disclosure, the SCU provides a single high-power control output, which is rated for 5 A at 250 VAC and is intended to drive a heater directly. Optional outputs could include: a low-power alarm output, an analog output for temperature, an analog output for the liquid level, and an RTD output. The low-power alarm output is rated for 1 A at 30 VDC, or 0.3 A @ 125 VAC; as the name suggests, it is meant to provide an alarm signal to a supervisory system, but, according to an exemplary embodiment, it can also be configured to switch a refill valve or even power a small pump. As for the analog outputs, these are current-based signals or voltage-based signals which are scaled to provide a continuous representation of the temperature or liquid level. Lastly, the RTD output makes use of an additional RTD, which operates in parallel with the silicon temperature sensor 56. This provides a 3-wire interface such that temperature can be measured using any device with a standard RTD input. The interface with the probe is made through the connector 52 or a multi-conductor cable 58. The minimum requirement is 6 connections for power, communication and the control output signal. Additional options, like the low-power alarm output or analog output, will require additional connections.

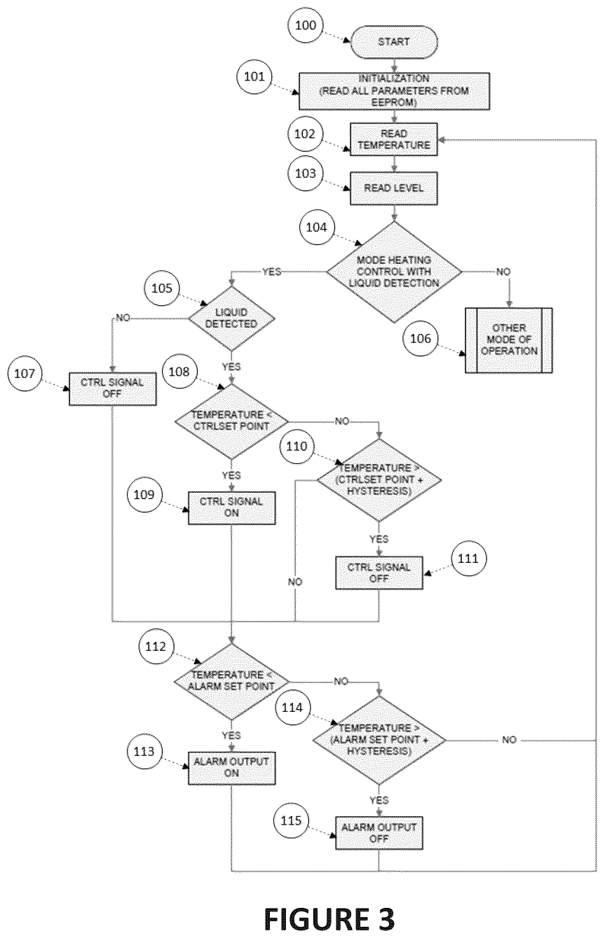

The scaler/control module 5 is loaded with firmware, which manages the functioning of the SCU; FIG. 3 shows the flow chart of this method (100), according to an exemplary embodiment of the disclosure. During the boot up sequence, the processor undergoes an initialization step 101 in which it configures the random-access memory (RAM), reads the configuration parameters from the electrically erasable programmable read-only memory (EEPROM), and uses those parameters to configure the peripheral devices. After the system has been initialized, the microprocessor will then read both the temperature (step 102) and liquid level (step 103). While the device can operate in a variety of user-programmable modes (step 106), the firmware contains a default mode which can be used to send an instruction signal to a heater operatively connected thereto, to heat a liquid subject to the condition of a positive detection of liquid by the level sensor.

According to an embodiment of the disclosure, assuming that the “heating control with liquid detection” mode been selected (step 104), then the processor will first determine whether the liquid has been detected (step 105). If it has not, then the control signal will be turned off (step 107). Otherwise, the processor will continue to evaluate whether the sensed temperature is less than the user-defined control set-point (step 108); provided that this is true, then the control output will be turned on (step 109). If not, then it will be turned off (step 111), as long as the liquid has reached a temperature which exceeds a user-defined hysteresis region (step 110). Once the control signal has been set, the processor will move on to determining the state of the alarm output.

To define the alarm output, the processor first determines whether the current temperature is less than the user-defined alarm set point (step 112), if it is, then the alarm output will be turned on (step 113). Otherwise, the alarm output will be turned off (step 115), provided that the liquid has reached a temperature which exceeds a user-defined hysteresis region (step 114). Once both the control signal and the alarm output have been set, the firmware loops back to reading the sensors and the process repeats.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A sensing and control unit for detecting and regulating both temperature and liquid level, comprising:
a temperature sensor and a liquid level sensor which are both integrally housed within the sensing and control unit;
a scaling and control module; and
an output module for sending a signal for temperature control a signal for level control,
wherein said temperature sensor, liquid level sensor, scaling and control module, and output module are housed within a common enclosed unit which is the sensing and control unit.

2. The sensing and control unit of claim 1, wherein said scaling and control module is remotely programmable.

3. The sensing and control unit of claim 1, wherein said scaling and control module is used to transmit the conditioned temperature and level signals.

4. The sensing and control unit of claim 1, wherein said temperature sensor, liquid level sensor, scaling and control module, and output module are integrated onto a single board which is within the common enclosed unit which is the sensing and control unit.

5. The sensing and control unit of claim 4, wherein the common enclosed unit which is the sensing and control unit is formed of a main housing and a probe extending from the main housing.

6. The sensing and control unit of claim 4, wherein the main housing and the probe have an inner volume thereof in common, thereby together forming the common enclosed unit.

7. The sensing and control unit of claim 6, wherein the single board comprising the temperature sensor, the liquid level sensor, the scaling and control module, and the output module, extends within the inner volume of the main housing and within the probe of the sensing and control unit.

8. The sensing and control unit of claim 7, wherein the main housing is elongated and extends from a proximal end to a distal end.

9. The sensing and control unit of claim 8, wherein the main housing is hexagonal at the proximal end and has a NPT connection at the distal end.

10. The sensing and control unit of claim 8, wherein the probe comprises a tube concentric with a bore of the main housing for connecting thereinto at the distal end of the main housing.

11. The sensing and control unit of claim 10, wherein the temperature sensor is located in the probe.

12. The sensing and control unit of claim 11, wherein the temperature sensor is a silicon temperature sensor.

13. The sensing and control unit of claim 11, wherein a printed circuit board extends within the main housing and protrudes into the probe by a distal end of the probe, forming a protrusion, the temperature sensor is mounted on the protrusion of the printed circuit board, thereby mounting the temperature sensor at the distal end of the probe.

14. The sensing and control unit of claim 13, wherein the protrusion of the printed circuit board includes a plurality of snap locations at regular locations for snapping off a distal portion of the protrusion to adapt to different probe lengths.

15. The sensing and control unit of claim 14, wherein the protrusion of the printed circuit board comprises solder pads immediately proximal of each of the plurality of snap locations for soldering the temperature sensor at the distal end of the probe upon snapping off the distal portion of the protrusion.

16. The sensing and control unit of claim 15, wherein the liquid level sensor is located in the probe.

17. The sensing and control unit of claim 16, wherein the liquid level sensor comprises two tubes made of an electrically-conductive material as a pair of isolated electrodes, a continuity between the two tubes changing upon submersion in a liquid indicating a level of the liquid.

18. The sensing and control unit of claim 17, wherein the scaling and control module, and the output module are housed within the main housing.

19. The sensing and control unit of claim 18, wherein the scaling and control module, and the output module receive signals from the temperature sensor and the liquid level sensor and can output a control on the temperature and on the liquid level.
